(19) United States
(12) Patent Application Publication
(10) Pub. No.: US 2014/0030687 A1
(43) Pub. Date: Jan. 30, 2014

(54) INCLUDING USAGE DATA TO IMPROVE COMPUTER-BASED TESTING OF APTITUDE

(71) Applicant: UNILOC LUXEMBOURG, S.A., Luxebourg (LU)

(72) Inventor: Craig S. ETCHEGOYEN, Plano, TX (US)

(21) Appl. No.: 13/944,618

(22) Filed: Jul. 17, 2013

Related U.S. Application Data
(60) Provisional application No. 61/676,736, filed on Jul. 27, 2012.

(51) Int. Cl. G09B 7/00

(52) U.S. Cl. CPC G09B 7/00
USPC 434/350

(57) ABSTRACT

Administration of an aptitude test is limited to one or more explicitly authorized computers associated with the user and usage of each computer is monitored during administration of the test and evaluated to make inferences regarding the user's aptitude beyond the direct results of the test. If the computer used by an authenticated is not properly authorized for the user, much tighter authentication is required to add the computer as an authorized computer. In addition, the server determines an approximate geological location of the computer. If the computer is determined to be at a location the user is not expected to be, the server refuses to administer the test. The server receives the responsive solutions provided by the user along with usage data representing usage of the user's computer during the pendency of each challenge. In evaluating the test results, the usage data is used to make one or more inferences of the user's aptitude.

This application claims priority pursuant to 35 U.S.C. §119(e) to U.S. provisional application Ser. No. 61/676,736, filed Jul. 27, 2012, which application is specifically incorporated herein, in its entirety, by reference.

### BACKGROUND OF THE INVENTION

1. Field of the Invention

The present invention relates generally to computer network services and, more particularly, to methods of and systems for attaching a behavior profile to the user of a networked computer according to its usage.

2. Description of the Related Art

Individuals today are often tested by institutions, government and businesses for variety of purposes ranging from hiring and school admission to help determine the aptitude and personality of an applicant. Some such testing allows the person being tested to use one or more computer devices during testing. Those who take aptitude tests sometimes are allowed to take the tests at home, rather than on site. There are inherent uncertainties, however, when allowing computer usage during aptitude testing and personality evaluation, especially during off-site testing, in that it can be difficult to ascertain that the test shows results solely from the person to whom the test was assigned. In some cases, subjects under test have been known to hire people from foreign countries to take an exam for them. In other cases, persons being tested may simply call friends for help during the exam, if they believe such help will improve their results.

To get the most believable and reliable results, it would be desirable to verify the identity of the person answering the questions and to know whether or how often they consulted sources to help them, what those sources were and how they were accessed. Knowing what devices or resources were used, how often, for how long, and for what purpose, could add a significant dimension to the test results, perhaps verifying or even contradicting the results, thereby improving the quality and value of computer-aided testing.

### SUMMARY OF THE INVENTION

In accordance with the present invention, administration of an aptitude test is limited to one or more explicitly authorized computers associated with the user and usage of each computer is monitored during administration of the test and evaluated to make inferences regarding the user's aptitude beyond the direct results of the test.

Upon authentication of the user, the computer through which the user is authenticated sends its digital fingerprint as its identifier. The server administering the test verifies that the computer is properly authorized for the user. If the computer is not properly authorized for the user, much tighter authentication is required to add the computer as an authorized computer, such tighter authentication preferably requiring that the user divulge sensitive, personal information that the user would prefer to keep from those offering to fraudulently take tests for hire. In addition, the server determines an approximate geological location of the computer. If the computer is determined to be at a location where the user is not expected to be, the server refuses to administer the test.

Each test includes a number of test items that can be organized into aptitude categories. Each test item includes a challenge to the user and a correct responsive solution to the challenge. For example, each challenge can be a question and the correct responsive solution can be a correct answer to the question. The user's computer monitors its usage from the time that a challenge is presented to the user and a responsive solution is provided by the user. Usage data representing such usage includes web browser and other software application activity, the use of files on the computer, time taken on each question and each category of questions, computer(s) used, and any efforts to contact others for help or to have someone else take the test.

The server receives the responsive solutions provided by the user along with usage data representing usage of the user's computer during the pendency of each challenge. In evaluating the test results, the usage data is used to make one or more inferences of the user's aptitude, beyond what the user's responsive solutions would indicate. A number of aptitude inference rules specify to what types of usage data each rule is applicable and an inference to be made when a matching usage data item is found. The inferences by application of aptitude inference rules accumulate to provide overall aptitude inferences of the user.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a server computer that gathers and analyzes usage data from one or more of a test-taker's computer devices and network attached storage through a computer network in accordance with one embodiment of the present invention.

FIG. 2 is a transaction flow diagram illustrating the manner in which a client computer and server computer of FIG. 1 cooperate to send an aptitude test to the client computer.

FIG. 3 is a transaction flow diagram showing tight authentication wherein the generated digital fingerprint of a client computer device which has been generated by the client computer device and added to the fingerprints of the user's devices is acknowledged to be acceptable.

FIG. 4 is a block diagram showing authorization data of server computer 106 of FIG. 1.

FIG. 5 is a transaction flow diagram showing how server 106 of FIG. 1 and a client computer device 102 of FIG. 1 cooperate to process each question of the aptitude test.

FIG. 6 is a block diagram of data used by server 106 of FIG. 1 during testing.

FIG. 7 is a transaction flow diagram illustrating the adjustment of aptitude inference by server 106 of FIG. 1.

FIG. 8 is a block diagram test results data gathered by server 106 of FIG. 1 during testing.

FIG. 9 is a block diagram of usage data seen in FIG. 8.

FIG. 10 is a block diagram of aptitude inference rules and aptitude inferences used by server computer 106 of FIG. 1.

FIG. 11 is a block diagram of a client computer device 102 shown in greater detail.

FIG. 12 is a block diagram of server computer 106 shown in greater detail.

### DETAILED DESCRIPTION

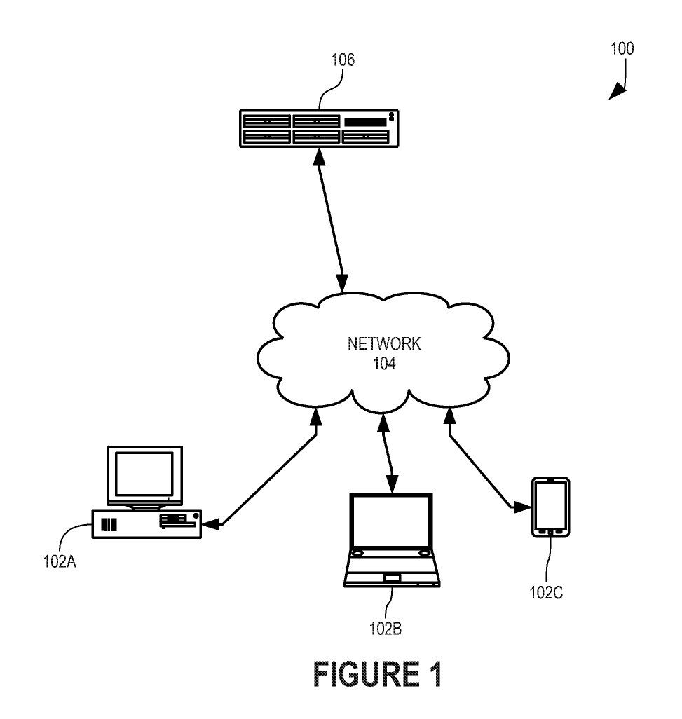

In accordance with the present invention, aptitude testing of an individual is limited to one or more client computers 102A, 102B, and 102C (FIG. 1) associated with the individual and usage of those devices is monitored during administration of aptitude testing to determine to what degree the individual relied on information gathered from extrinsic sources. A networked server computer 106 gathers data over a network 104 from one or more explicitly authenticated devices used when taking the test remotely, rather than being monitored locally on site. In an illustrative embodiment, client computers 102A, 102B, and 102C (FIG. 1) are all devices belonging to the individual being tested and available for the individual's use during the test. The individual taking the aptitude test in this illustrative embodiment will sometimes be referred to herein as the user.

Client computer 102A is a desktop computer, client computer 102B is a laptop computer, and client computer 102C is a smart phone. As described more completely below, each of client computers 102A-C is registered with server computer 106 prior to the test via their respective digital fingerprints, which are used during the test to authorize any use of each of the client computers. Each of client computers 102A, 102B, and 102C communicates with server 106 through network 104. Client computers 102A, 102B, and 102C are analogous to one another and description of the use of client device 102A is equally applicable to client devices 102B and 102C unless otherwise noted herein. While three (3) client computers 102A-C are shown in this illustrative example, fewer or more client computers can be used by the individual taking the aptitude test.

Information including the usage of files resident on the client computers, the time taken on each test category and the information accessed via the web browser of each of client computers 102A-C is gathered from client computers 102A-C during the test by server computer 106 and used by server computer 106 to adjust the test results, thereby adding another dimension to the information normally available from aptitude testing which otherwise restricts results to inferring aptitude from answers alone. Spending significantly more time answering questions in a particular category or looking for help from the web suggests weakness in a category, while use of a simpler computing device for a category of questions and quick answers suggests strength in a category. On the other hand, some test questions may be designed to compel the test taker to seek answers by browsing the web, and additional aptitude indicators may be derived based on information such as search engine or browser selected, URL selected, and search criteria entered by the test taker.

Server computer 106 can be any type of data server that serves requests for data management from other computing devices, e.g., through a network such as network 104. In this illustrative embodiment, network 104 is the Internet. And in this embodiment, data made accessible to client computers 102A, 102B, and 102C by server computer 106 includes aptitude test questions. Data gathered from one or more of the client computers 102A, 102B, and 102C includes user-authentication data, answers made by the user to the test questions, computer devices and network sources used to answer each question and the time used to answer each category of questions.

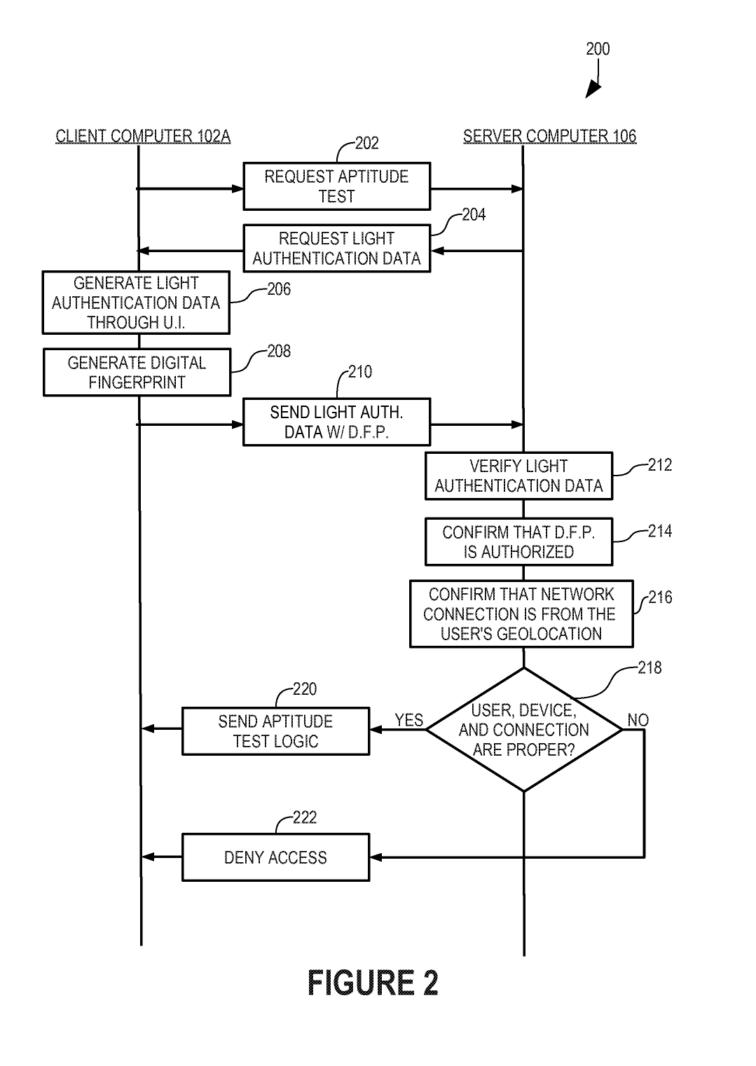

Transaction flow diagram 200 (FIG. 2) illustrates the manner in which server computer 106 controls access to its data, limiting such access to explicitly authorized users and client computing devices.

In step 202 (FIG. 2), client computer 102A requests access to the aptitude test served by server computer 106. The request can be in the form of a URL provided to the user for administration of the test.

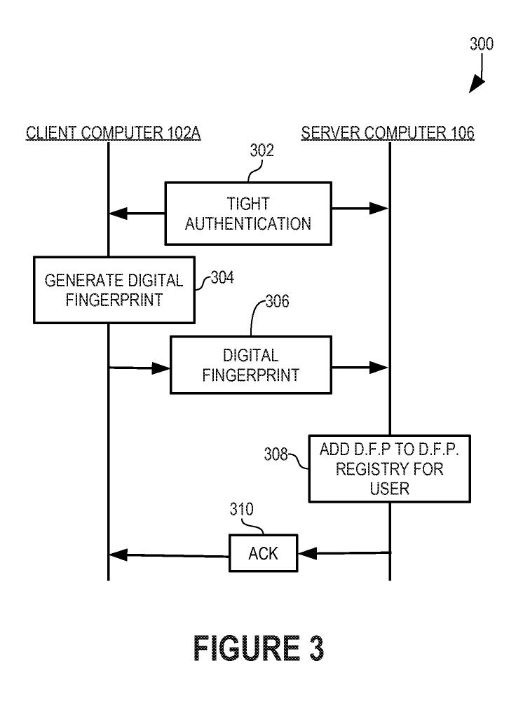

In response to the request by client computer device 102A for the aptitude test in step 202, server computer 106 in step 204 requests light authentication data of the user. Light authentication is light relative to tight authentication described below in conjunction with step 302 (FIG. 3). In this illustrative embodiment, server computer 106 requests a username and password combination and a digital fingerprint of client computer 102A. The request of step 204 can include web form and content prompting the user to enter a username and password and logic causing client computer 102A to generate a digital fingerprint of itself.

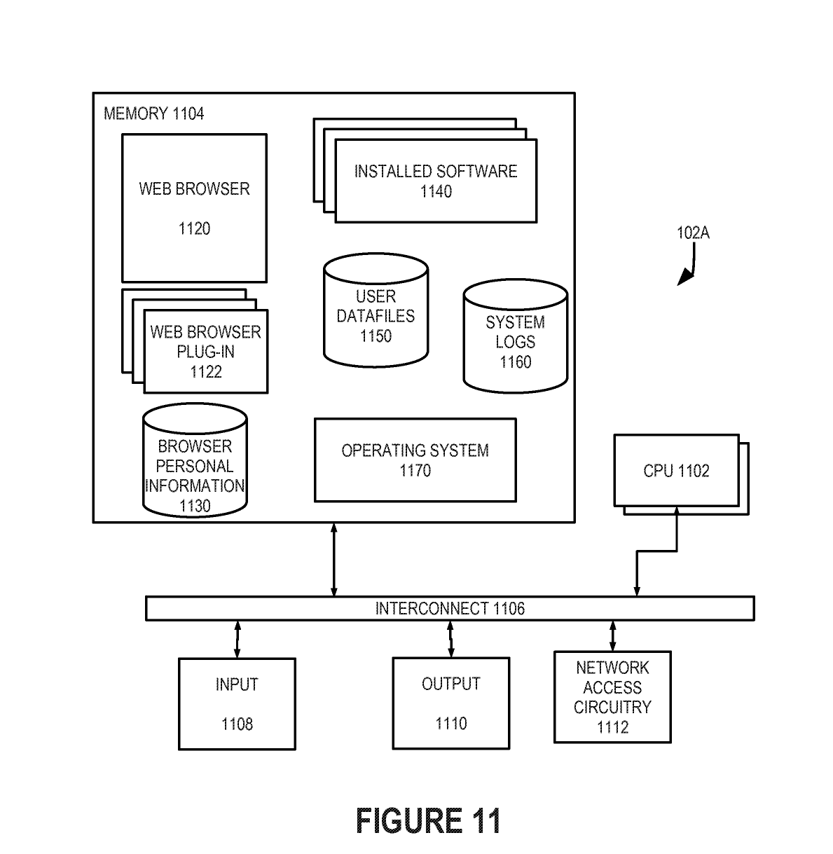

In step 206, the user enters the authentication information requested in step 204 using conventional user interface techniques, including physical manipulation of user input devices 1108 (FIG. 11).

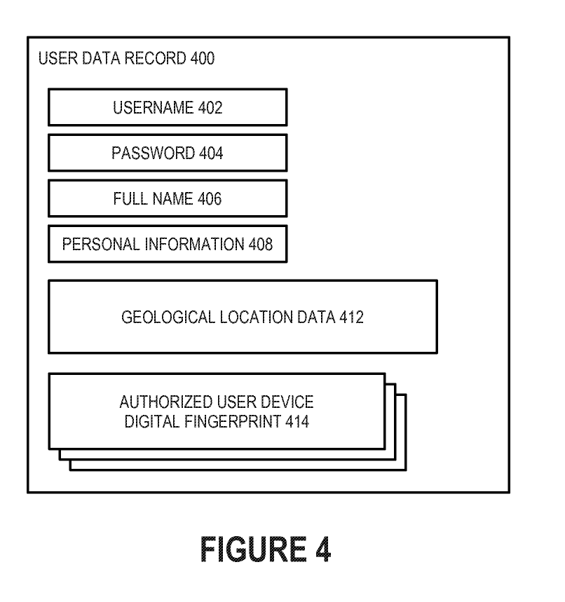

In step 208 (FIG. 2), client computer 102A generates its digital fingerprint 414 (FIG. 4). Digital fingerprints of computing devices and generation thereof are known and are described, e.g., in U.S. Pat. No. 5,490,216 (sometimes referred to herein as the '216 patent), and in related U.S. Patent Application Publications 2007/0143073, 2007/0126550, 2011/0093920, and 2011/0093701 (the “related applications”), the descriptions of which are fully incorporated herein by reference.

In general, the digital fingerprint 414 comprises a bit string or bit array that includes or is derived from user-configurable and non-user-configurable data specific to the user's fingerprintable computing device 102A. Non-user-configurable data includes data such as hardware component model numbers, serial numbers, and version numbers, and hardware component parameters such as processor speed, voltage, current, signaling, and clock specifications. User-configurable data includes data such as registry entries, application usage data, file list information, and MAC address. In one embodiment, the digital fingerprint 306 can also include, for example, manufacture name, model name, and/or device type of the device 102A. In one embodiment, the digital fingerprint 414 can include hardware attributes of the device 102A which are retrievable by the computing device 102A through an API from the hardware device driver for the device 102A.

Generation of the digital fingerprint 414 includes a combination of operations on the data specific to the device 102A, which may include processing using a combination of sampling, concatenating, appending (for example, with a nonce value or a random number), obfuscating, hashing, encryption, and/or randomization algorithms to achieve a desired degree of uniqueness. For example, the desired degree of uniqueness may be set to a practical level such as 99.999999% or higher, to achieve a probability of less than 1 in 100,000,000 that any two computing devices 102A, 102B (etc.) will generate identical fingerprints. In an embodiment, the desired degree of uniqueness may be such that the digital fingerprint 414 generated is unlike any other device fingerprint generatable for a computing device 102A.

Logic causing client computer 102A to generate its digital fingerprint can be in installed software 1140 (FIG. 11), a web browser plug-in 1122, or included in the request of step 204 (FIG. 2) or a combination of these.

In step 210, client computer 102A sends the light authentication data gathered in step 206 and the digital fingerprint generated in step 208 to server computer 106.

In step 212, server computer 106 verifies the light authentication data.

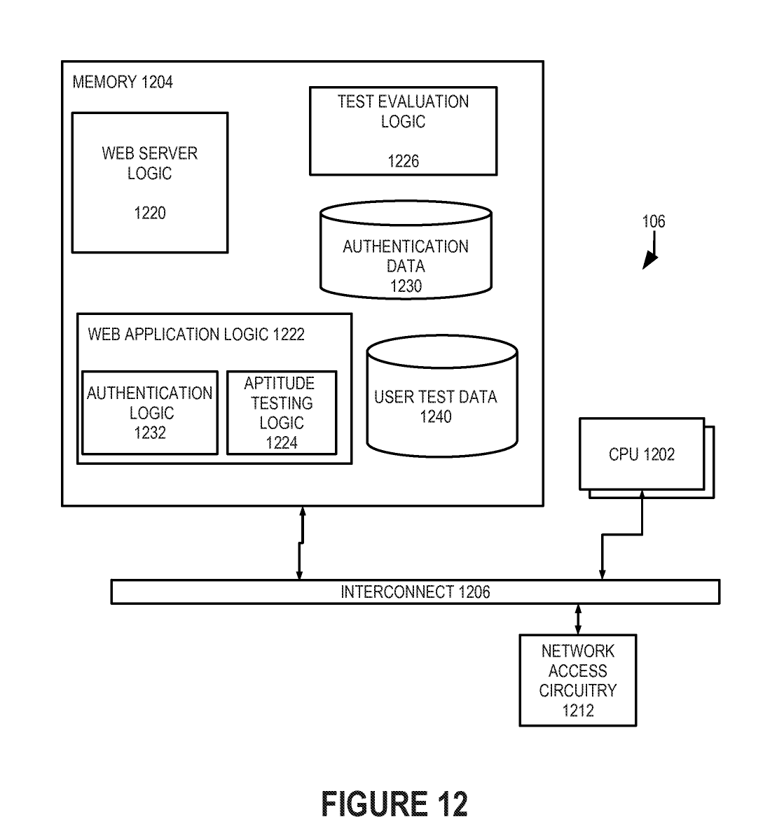

As described below, server computer 106 includes authentication logic 1232 (FIG. 12) and authentication data 1230 (FIG. 12), which is used by authentication logic 1232 to determine whether to grant or deny requests for access to the aptitude testing logic 1240 (FIG. 12). Authentication data 1230 includes user data records such as user data record 400 (FIG. 4) for each user authorized to take the test administered by server computer 106. To verify light authentication data received from client computer 102A, authentication logic 1232 determines whether the received username and password match username 402 and password 404 of any user data record in authentication data 1230 (FIG. 12).

In step 214 (FIG. 2), authentication logic 1232 determines whether the digital fingerprint received in step 210 is authorized for the user identified by the username and password combination. User data record 400 (FIG. 4) includes digital fingerprints 414 for each device authorized to be used by the user in taking the test. If the digital fingerprint received in step 210 (FIG. 2) matches any of digital fingerprints 414, authentication logic 1232 determines that client computer 102A is authorized,

In step 216, authentication logic 1232 determines whether the light authentication data and digital fingerprint are received in step 210 from a geological location at which the user is believed to be. In one embodiment, authentication logic 1232 determines the geological location of client computer 102A using IP (internet protocol) trace routing or other network-based geological location detection techniques to determine the general location of client computer 102A. In an alternative embodiment, client computer 102A determines its geological location using any of a number of techniques, including GPS circuitry, to determine its own location and includes data representing the location in the digital fingerprint.

User data record 400 (FIG. 4) includes geological location data 412, representing a geological location at which the user is expected to be. In determining whether the user is at a reasonable location, authentication logic 1232 does not require that the user be at any particular address or very specific location represented in geological location data 412 but within a predetermined distance, such as a hundred miles for example. In determining whether the client computer 102A is at a geological location at which the user could reasonably be, authentication logic 1232 can store data indicative of locations from which the user has taken portions of the test in the past and how frequently the location changes. In addition, authentication logic 1232 can refuse to allow taking of the test from geological regions with reputations for fraudulent test taking.

There are currently a number of conventional authentication protocols for remote data access. Some rely solely on a username-password combination. Others include filters for allowed and denied IP (Internet Protocol) and MAC (Media Access Control) addresses. Such authentication factors are either easily discoverable or dependent upon a human user for security and all are easily spoofed by an unauthorized, malevolent user. By comparison, digital fingerprints are complex, very tightly coupled to a particular computing device, and extremely difficult to discover or spoof. Accordingly, in the illustrative embodiment it is extremely difficult for a computer other than client computers 102A, 102B, and 102C to have access to the individual digital fingerprints of client computers 102A, 102B, and 102 C.

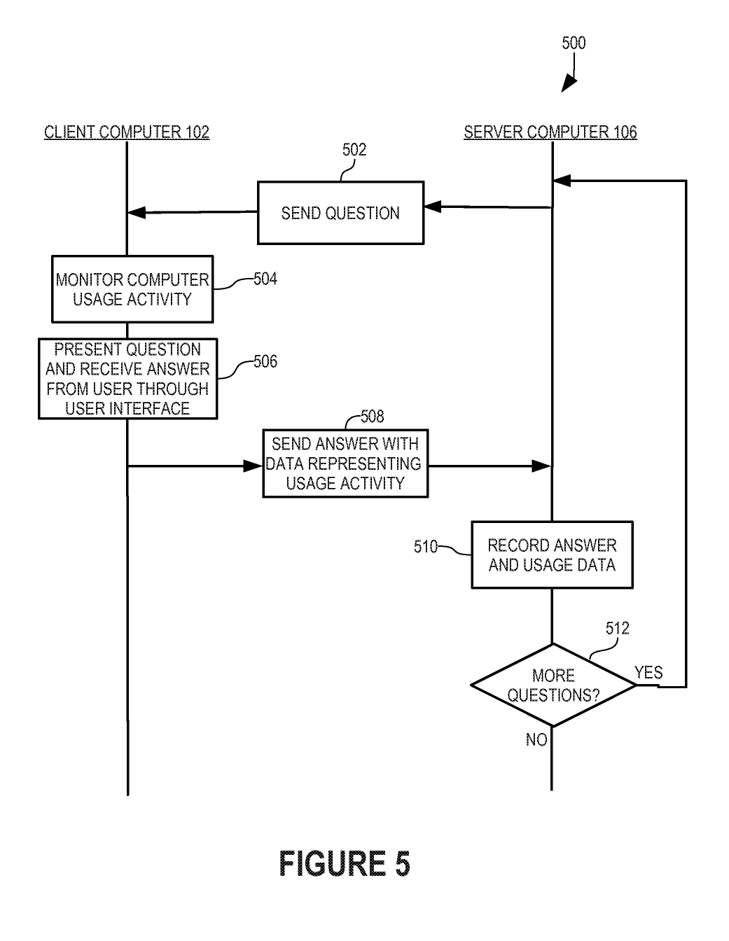

If authentication logic 1232 verifies that the light authentication data is valid in step 212, that the digital fingerprint confirms that client computer 102A is authorized for the user in step 214, and that client computer 102A is at a location at which the user can reasonably be expected to be in step 216, processing transfers through test step 218 to step 220. In step 220, aptitude testing logic 1224 proceeds to administer the test to the user through client computer 102A. Administration of the test by aptitude testing logic 1224 is described in greater detail below in conjunction with transaction flow diagram 500 (FIG. 5).

Conversely, if authentication logic 1232 (FIG. 12) verifies that the light authentication data is invalid in step 212 (FIG. 2), that the digital fingerprint fails to confirm that client computer 102A is authorized for the user in step 214, or that client computer 102A is not at a location at which the user can reasonably be expected to be in step 216, processing transfers through test step 218 to step 222. In step 222, authentication logic 1232 refuses to administer the test to the user through client computer 102A.

In this illustrative embodiment, if authentication logic 1232 verifies that the light authentication data is valid in step 212 (FIG. 2) and that client computer 102A is at a location at which the user can reasonably be expected to be in step 216 but that the digital fingerprint fails to confirm that client computer 102A is authorized for the user in step 214, authentication logic 1232 can offer to add the digital fingerprint received in step 210 to the authorized digital fingerprints represented in digital fingerprints 414 (FIG. 4). The authorization of another digital fingerprint is illustrated in transaction flow diagram 300 (FIG. 3).

In step 302, authentication logic 1232 cooperates with client computer 102A to perform tight authentication of the user. While light authentication can involve simple, two-factor authentication such as a username and password combination, tight authentication requires additional factors. In this illustrative embodiment, user data record 400 includes a full name 406 and personal information 408. It is preferred that personal information 408 includes information that the user would rather not share with others. For example, if the test is a scholastic test for which payment is required, personal information 408 can include billing information for the user. Or, if the test is an aptitude test required by an employer, personal information 408 can include bank account information to be used for electronic payments of salary to the user. By requiring that the user provide personal information 408 during tight authentication in step 302, the user is discouraged from hiring another to take the test fraudulently. Presumably, the user would be reluctant to provide bank account or billing information to someone sufficiently unscrupulous to perpetrate fraud for hire.

In step 304, client computer 304 generates its digital fingerprint in the manner described above with respect to step 208 (FIG. 2). In step 306 (FIG. 3), client computer 102A sends its digital fingerprint to server computer 106.

In step 308, authentication logic 1232 adds the digital fingerprint received in step 306 to digital fingerprints 414 (FIG. 4) of the user data record of the user. In step 310, authentication logic 1232 acknowledges successful registration of client computer 102A to the user. After step 310, client computer 102A can be used to lightly authenticate the user and to take the test.

In this illustrative example, the test is available to any of the three client computers 102A, 102B, and 102C that have gone through the registration process of transaction flow diagram 300 (FIG. 3).

As described above briefly, the context of the user's behavior while taking the test provides useful information regarding the user's aptitudes being tested. For example, just which client computer is used on a given question or a particular category of questions is often influenced by the user's aptitude. A category that the user finds easy may well encourage the use of a mobile device such as client computer 102C or a laptop such as client computer 102B. More difficult questions will encourage the use of a desktop computer such as client computer 102A in a quiet place where better concentration is needed and more reliable and faster access to Web information or information stored on the client computer during previous use that might can help clarify the question or simply provide the answer. During administration of the test, the usage of each client computer is monitored as is the access by them in an effort to find answers to the questions. A longer period to answer a question or more time spent on a category of questions suggests greater difficulty. In addition, efforts to use any of these client computers to contact other individuals for help including instant messaging or Internet-based phone calls, is also monitored.

This ability to monitor the usage of the client computers provides another dimension to the test results, adding to the information acquired simply by the answers given.

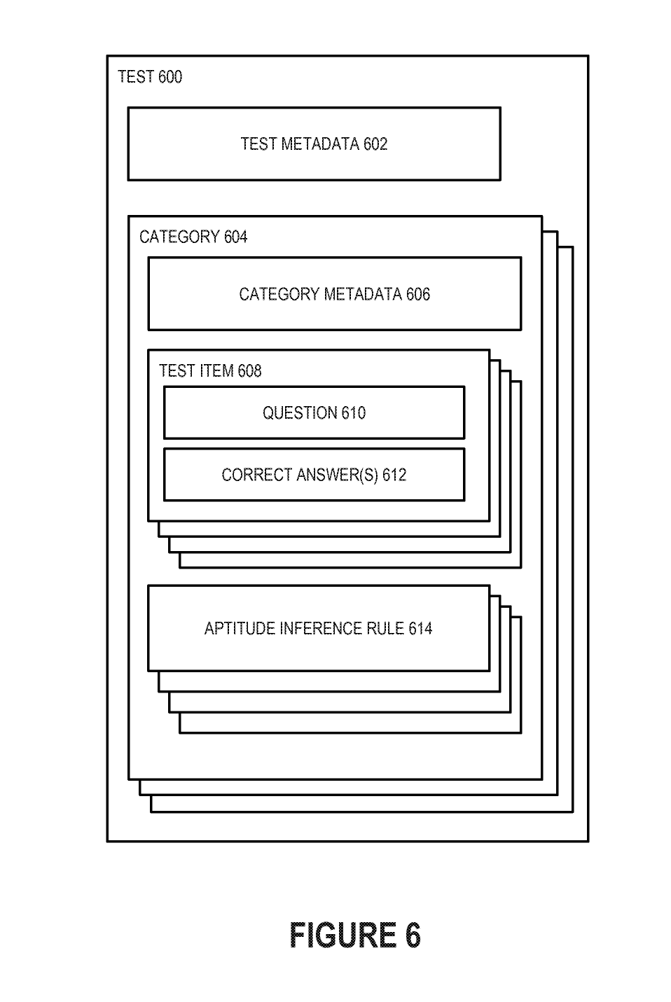

After authorization is granted to the user of client computer 102A in the manner describe above with respect to transaction flow diagram 200 (FIG. 2), server computer 106 refers to test 600 (FIG. 6) stored in user test data 1240 (FIG. 12). Test 600 (FIG. 6) includes test metadata 602 that provides general information about test 600, such as a general description of the test and perhaps instructions for completing the test represented by test 600.

In addition, test 600 includes a number of categories 604, each of which is designed to test a particular type of aptitude of the user. Each category 604 includes category metadata 606, which can provide general information about the category, such as a general description of the category and perhaps instructions for answering questions of category 604.

Each category includes a number of test items 608, each of which in turn includes a question 610 and a correct answer 612. Correct answer 612 can specify that more than one answer to question 610 is considered correct.

In addition, each category includes a number of aptitude inference rules 614. In a manner described below in greater detail, test evaluation logic 1226 (FIG. 12) of server computer 106 uses aptitude inference rules 614 (FIG. 6) to make inferences regarding the user's test results according to client computer usage during testing.

In this illustrative embodiment, aptitude inference rules 614 are associated with categories 604. In alternative embodiments, aptitude inference rules can be associated with individual test items or with the entire test. In other words, the scope of an aptitude inference rule can be very broad, very specific, or something in between. In addition, a test can have only a single category, making test metadata 602 and category metadata 606 redundant. It should be appreciated that the particular organization of test 600 is merely illustrative.

Transaction flow diagram 500 (FIG. 5) illustrates taking at least a portion of the test represented by test 600. In step 502, aptitude testing logic 1224 (FIG. 12) prompts the user to answer a question 610 (FIG. 6).

Upon receipt of the question in step 502, client computer 102A begins in step 504 to monitor the usage activity of client 102A, recording the user's reaction to the question, including time and other usage of client computer 102A until the user has entered an answer to the question, e.g., using conventional user interface techniques involving physical manipulation of user input devices 1108 (FIG. 11).

In step 506 (FIG. 5), client computer 102A presents the question to the user and the user enters an answer to the question.

In step 508, the user of client computer 102A sends the answer to the question along with data representing usage of client computer 102A between presentation of the question to the user and entry of the answer by the user to server computer 106. The manner in which usage of a computer can be monitored is described in U.S. Provisional Patent Application 61/676,251 and that description is incorporated herein by reference. In one embodiment, the usage data identifies client computer 102A as the particular client computer used to respond to the question. In an alternative embodiment, server computer 106 remembers which client computer is used throughout transaction flow diagram 500 (FIG. 5) after authentication as described above with respect to transaction flow diagram 200 (FIG. 2).

In step 510 (FIG. 5), server computer 106 records the answer and the usage data in user test data 1240 of FIG. 12. If server computer 106 determines, in step 512, that there is another test question for the user, the process returns to step 502 where server computer 106 sends another question to client computer 102. When the user has answered all questions of the test or has asked that the test be suspended until a later time, processing according to transaction flow diagram 500 completes. When the test is suspended upon request by the user, the user can use any authorized client computer to resume taking the test.

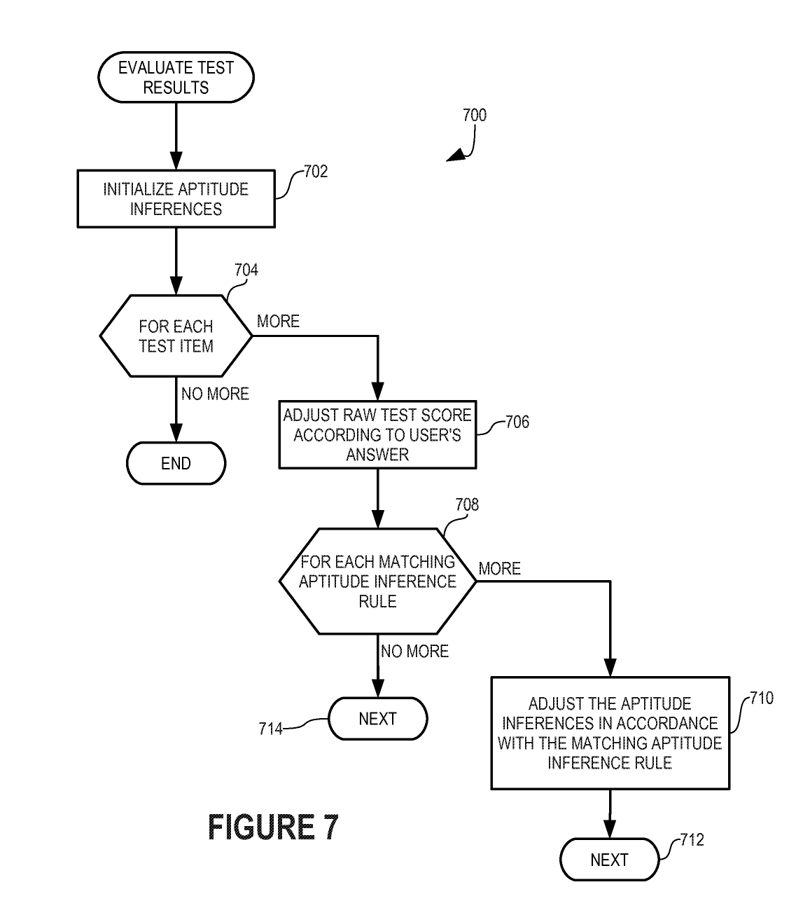

When the test is completed, test evaluation logic 1226 (FIG. 12) of server computer 106 evaluates the user's answers and computer usage to assess the user's aptitude in one or more categories. The manner in which the test results are evaluated by test evaluation logic 1226 is illustrated in logic flow diagram 700 (FIG. 7).

In step 702, test evaluation logic 1226 initializes all aptitude inferences to a neutral state, representing no inference at all. In this illustrative embodiment, there is a single aptitude inference for each category of test 600. Each aptitude inference represents whether the user's true aptitude of a given category is likely greater than or less than indicated by the test results for that category and how likely. For example, if the user answers questions rapidly on a smart phone and engages in no non-test-related activity or solves a Freecell or other complex solitaire puzzle on the smart phone, the user likely had a very easy time of answering the questions in that category and her true aptitude is very likely greater than the test results for that category would indicate. Conversely, if the user answered questions very slowly using a desktop computer and performed frequent web searches and messages and calls while each question was awaiting an answer, the user's true aptitude in that category is very likely less than indicated by the test results for that category.

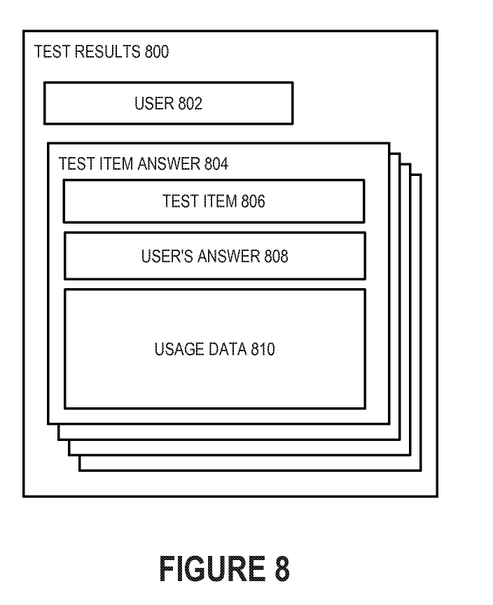

Loop step 704 and next step 714 define a loop in which test evaluation logic 1226 processes each test item answer 804 (FIG. 8) of test results 800 according to steps 706-712 (FIG. 7). During a particular iteration of the loop of steps 704-714, the particular test item processed is sometimes referred to as the subject test item.

Test results 800 identify the user to which test results pertain in user 802. In addition, test results 800 include a test item answer 804 for each question answered by the user. Each test item answer 804 includes a test item 806, a user's answer 808, and usage data 810.

Test item 806 identifies a particular test item 608 (FIG. 6) of test 600. User's answer 808 (FIG. 8) represents the answer the user gave in response to question 610 (FIG. 6). Usage data 810 (FIG. 8) represents usage of the particular client computer used by the user in answering the question.

In step 706 (FIG. 7), test evaluation logic 1226 adjusts the user's raw test score according to the answer provided by the user. Test evaluation logic 1226 compares user's answer 808 of the subject test item to correct answer 612 of the test item 608 identified by test item 806. In this illustrative embodiment, test evaluation logic 1226 adds one point to the user's raw test score for the subject category if user's answer 808 matches the corresponding correct answer 612 and does not change the user's raw score otherwise. In alternative embodiments, test evaluation logic 1226 can add a number of points to the raw score for a correct answer, subtract a number of points for a wrong answer, and not change the raw score for no answer at all. Test evaluation logic 1226 can use any of a number of point systems for evaluating the user's answers to the questions of the category.

Loop step 708 and next step 712 define a loop in which test evaluation logic 1226 processes each aptitude inference rule 614 (FIG. 6) of the subject category that matches usage data 810 (FIG. 8) of the subject test item.

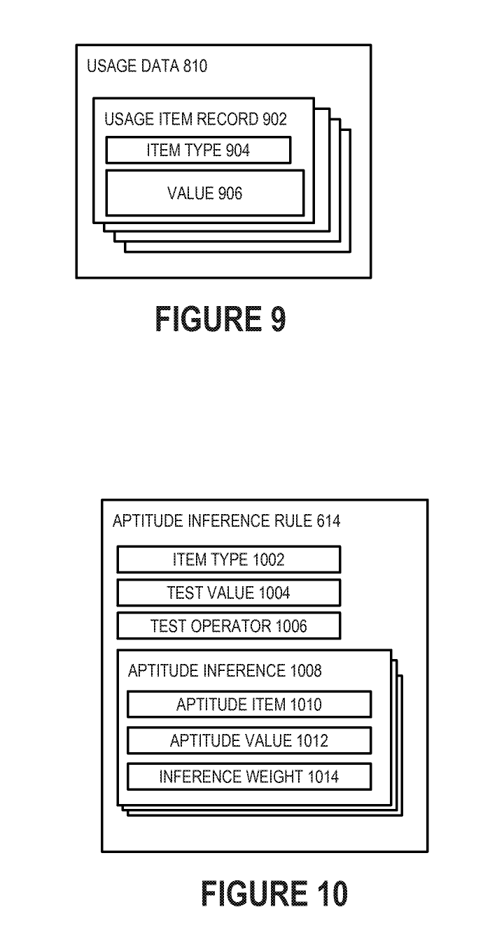

Usage data 810 is shown in greater detail in FIG. 9. Usage data 810 includes a number of usage item records 902. Each usage item record 902 includes an item type 904 and a value 906. Item type 904 specifies a type of usage information. Value 906 is data representing the recorded usage of the specified type.

There are a wide variety of types of usage information that can be represented within usage item records 902. For example, an HTTP request issued by web browser 1120 represents an attempt of the user to retrieve and view a web page, and the associated value can include the URL. Such would show an attempt by the user to look up information helpful in answering the subject test item. Initiation of a telephone call, whether using voice over IP logic within client computers 102A-B or wireless telephony logic within client computer 102C, can be another type of usage information. Other types of usage information can include use of installed software, such as dictionaries, calculators, instant messaging, reading e-books, etc. Associated values can specify details of such usage, such as the specific queries made by the user, time stamps, the information received in response to the queries, and the particular client computer 102A, 102B, or 102C used and the amount of time taken to answer the subject test item.

An aptitude inference rule 614 (FIG. 6) is shown in greater detail in FIG. 10. Aptitude inference rule 614 includes an item type 1002, a test value 1004, and a test operator 1006. Aptitude inference record 614 matches the usage information item represented by usage item record 902 (FIG. 9) if item type 1002 and item type 904 are the same and application of test value 1004 to value 906 with test operator 1006 yields a “true” result.

It may be helpful to consider the following example. Suppose item type 1002 (FIG. 10) specifies an HTTP request of a web browser, test value 1004 specifies a regular expression matched by URLs a number of web search tools, and test operator 1006 specifies a regular expression match operation. Aptitude inference record 614 would them match usage item record 902 if item type 904 indicates an HTTP request of a web browser and value 706 specifies a URL that is matched by the regular expression of test value 1004.

For each of aptitude inference rules 614 (FIG. 6) that match the subject test item, test evaluation logic 1226 processes the matching aptitude inference rule in the context of usage data 810 (FIG. 8) of the subject test item according to step 710 (FIG. 7). In step 710, test evaluation logic 1226 adjusts the aptitude inferences, which were initialized in step 702, in accordance with the matching aptitude inference rule.

Each aptitude inference rule 614 (FIG. 10) includes one or more aptitude inferences 1008. An aptitude item 1010 specifies a particular aptitude category whose inference is to be adjusted. While aptitude inference rule 614 is already associated with a particular category 604 (FIG. 6) within test 600, some questions can be related to multiple categories. For example, word problems in math tests also measure reading comprehension.

Aptitude value 1012 (FIG. 10) specifies an inference to made. In this embodiment, aptitude value 1012 indicates whether the inference is that the user is better or worse at the subject category than indicated by the raw score.

Inference weight 1014 specifies a weight to be given the inference of aptitude inference 1008. Stronger inferences have greater weights than weaker inferences.

In applying aptitude inferences 1008, test evaluation logic 1226 adjusts the aptitude inferences initialized in step 702 (FIG. 7). The adjustments of repeated performances of step 710 are cumulative.

Once all matching aptitude inference rules have been applied in the loop of steps 708-712, processing by test evaluation logic 1226 transfers through next step to loop step 704 and test evaluation logic 1226 processes the next of test item answers 804 (FIG. 8) according to the loop of steps 704-714. When all of test item answers 804 have been processed by test evaluation logic 1226, processing according to logic flow diagram 700 completes.

Through processes including those shown in FIGS. 2, 3, 5, and 7, server computer 106 infers user aptitude from the test results adjusted not only for the usual content of the answers to the test questions, but also taking into consideration the client computer used, the time used in answering questions and categories of questions, and efforts to access helpful information relating to a question.

Client computer 102A is shown in greater detail in FIG. 11 and includes one or more microprocessors 1102 (collectively referred to as CPU 1102) that retrieve data and/or instructions from memory 1104 and execute retrieved instructions in a conventional manner. Memory 1104 can include generally any computer-readable medium including, for example, persistent memory such as magnetic and/or optical disks, ROM, and PROM and volatile memory such as RAM.

CPU 1102 and memory 1104 are connected to one another through a conventional interconnect 1106, which is a bus in this illustrative embodiment and which connects CPU 1102 and memory 1104 to one or more input devices 1108, output devices 1110, and network access circuitry 1112. Input devices 1108 can include, for example, a keyboard, a keypad, a touch-sensitive screen, a mouse, and a microphone. Output devices 1110 can include, for example, a display—such as a liquid crystal display (LCD)—and audio speakers. Network access circuitry 1112 sends and receives data through a wide area network 104 (FIG. 1) such as the Internet and/or mobile device data networks. Client computer 102C also includes telephony circuitry for conducting voice phone calls.

A number of components of client computer 102A are stored in memory 1104. Operating system 1170, installed software 1140, web browser 1120, and web browser plug-ins 1122 are each all or part of one or more computer processes executing in CPU 1102 from memory 1104 in this illustrative embodiment but can also be implemented using digital logic circuitry. Browser personal information 1130, user data files 1150, and system logs 1160 are all data stored persistently in memory 1104 and each can be organized as all or part of one or more databases.

Server computer 106 (FIG. 1) is shown in greater detail in FIG. 12 and includes a CPU 1202, memory 1204, interconnect 1206, and network access circuitry 1212 that are directly analogous to CPU 1102 (FIG. 11), memory 1104, interconnect 1106, and network access circuitry 1112, respectively, of client computer 102A. Since server computer 106 (FIG. 12) is a server computer, input devices and output devices are omitted and server computer 106 interacts with human users exclusively through network access circuitry 1212.

A number of components of server computer 106 are stored in memory 1204. In particular, web server 1220, test evaluation logic 1226, and web application logic 1222, including authentication logic 1232 and aptitude testing logic 1224, are each all or part of one or more computer processes executing within CPU 1202 from memory 1204 in this illustrative embodiment but can also be implemented using digital logic circuitry. As used herein, “logic” refers to (i) logic implemented as computer instructions and/or data within one or more computer processes and/or (ii) logic implemented in electronic circuitry. Authentication data 1230 data stored persistently in memory 406, as is user test data 1240. Authentication data 1230 and user test data 1240 can each be organized as all or part of one or more databases.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for administering an aptitude test to a remotely located user of one or more remotely located computers, the method comprising:
receiving, via a computer network from each of the computers, authentication data representing the identity of both the computer and of the user;
receiving usage data from each computer used during the test, wherein the usage data includes items of usage data that represent activity of the computer from presentation of a challenge to the user to entry of a solution to the challenge by the user;
for each of the items of usage data:
determining that one or more applicable ones of one or more predetermined aptitude inference rules apply to an item of data; and
adjusting one or more aptitude inferences according to the applicable predetermined aptitude inference rules; and
inferring one or more characteristics of the user's aptitude from the aptitude inferences as adjusted.

2. The method of claim 1 wherein at least one of the items of usage data represents time that has elapsed between presentation of the challenge to the user and entry of the solution to the challenge by the user.

3. The method of claim 1 wherein at least one of the items of usage data represents browser use.

4. The method of claim 1 wherein at least one of the items of usage data represents the computer device used to enter the solution to the challenge.

5. The method of claim 1 further comprising:
determining whether the computer identified in the authentication data is authorized for the user;
determining whether the computer is located in a region in which the user is expected to be; and
upon a condition in which the computer identified in the authentication data is not authorized for the user or the computer is located in a region in which the user is not expected to be, refusing to administer the aptitude test.

6. A computer readable medium useful in association with a computer which includes one or more processors and a memory, the computer readable medium including computer instructions which are configured to cause the computer, by execution of the computer instructions in the one or more processors from the memory, to administer an aptitude test to a remotely located user of one or more remotely located computers by at least:
receiving, via a computer network from each of the computers, authentication data representing the identity of both the computer and of the user;
receiving usage data from each computer used during the test, wherein the usage data includes items of usage data that represent activity of the computer from presentation of a challenge to the user to entry of a solution to the challenge by the user;
for each of the items of usage data:
determining that one or more applicable ones of one or more predetermined aptitude inference rules apply to an item of data; and
adjusting one or more aptitude inferences according to the applicable predetermined aptitude inference rules; and
inferring one or more characteristics of the user's aptitude from the aptitude inferences as adjusted.

7. The computer readable medium of claim 6 wherein at least one of the items of usage data represents time that has elapsed between presentation of the challenge to the user and entry of the solution to the challenge by the user.

8. The met computer readable medium of claim 6 wherein at least one of the items of usage data represents browser use.

9. The computer readable medium of claim 6 wherein at least one of the items of usage data represents the computer device used to enter the solution to the challenge.

10. The computer readable medium of claim 6 wherein the computer instructions are configured to cause the computer to administer an aptitude test to a remotely located user of one or more remotely located computers by at least also:
determining whether the computer identified in the authentication data is authorized for the user;
determining whether the computer is located in a region in which the user is expected to be; and
upon a condition in which the computer identified in the authentication data is not authorized for the user or the computer is located in a region in which the user is not expected to be, refusing to administer the aptitude test.

11. A computer system comprising:
at least one processor;
a computer readable medium that is operatively coupled to the processor;
network access circuitry that is operatively coupled to the processor; and
aptitude testing logic (i) that executes at least in part in the processor from the computer readable medium and (ii) that, when executed, causes the computer system to administer an aptitude test to a remotely located user of one or more remotely located computers by at least:
receiving, via a computer network from each of the computers, authentication data representing the identity of both the computer and of the user;
receiving usage data from each computer used during the test, wherein the usage data includes items of usage data that represent activity of the computer from presentation of a challenge to the user to entry of a solution to the challenge by the user;
for each of the items of usage data:
determining that one or more applicable ones of one or more predetermined aptitude inference rules apply to an item of data; and
adjusting one or more aptitude inferences according to the applicable predetermined aptitude inference rules; and
inferring one or more characteristics of the user's aptitude from the aptitude inferences as adjusted.

12. The computer system of claim 11 wherein at least one of the items of usage data represents time that has elapsed between presentation of the challenge to the user and entry of the solution to the challenge by the user.

13. The computer system of claim 11 wherein at least one of the items of usage data represents browser use.

14. The computer system of claim 11 wherein at least one of the items of usage data represents the computer device used to enter the solution to the challenge.

15. The computer system of claim 11 wherein the aptitude testing logic causes the computer system to administer an aptitude test to a remotely located user of one or more remotely located computers by at least also:
determining whether the computer identified in the authentication data is authorized for the user;
determining whether the computer is located in a region in which the user is expected to be; and
upon a condition in which the computer identified in the authentication data is not authorized for the user or the computer is located in a region in which the user is not expected to be, refusing to administer the aptitude test.
